(19) United States
(12) Patent Application Publication
(10) Pub. No.: US 2010/0257413 A1
(43) Pub. Date: Oct. 7, 2010

(54) VERIFICATION SERVICE FOR DYNAMIC CONTENT UPDATE

(75) Inventors: Thomas A. Brunet, Round Rock, TX (US); Allen K. Wilson, Austin, TX (US); Shunguo Yan, Austin, TX (US)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/417,718

(22) Filed: Apr. 3, 2009

(51) Int. Cl. G06F 11/30

(52) U.S. Cl. 714/57; 714/E11.179

(57) ABSTRACT

A client-side application receives an initial page from an application server that includes initial content and provides the initial page to a user. Next, the client-side application receives user input corresponding to the initial page and updates a portion of the initial content, which results in updated content and unmodified initial content. Subsequently, the client-side application formats the updated content and adds markup tags that describe the updated content. The client-side application then sends the updated content and the markup tags to a verification server. As a result, the client-side application receives a verification report from the verification server that corresponds to the updated content and the markup tags. The client-side application determines whether the verification report includes a verification error and, if so, the client-side application provides the verification error to the user.

### BACKGROUND OF THE INVENTION

1. Technical Field

The present invention relates to a verification service for dynamic content update. More particularly, the present invention relates to a client-side application utilizing a server-based verification server to verify partially updated content against rules or policies for compliance.

2. Description of the Related Art

A computer system typically performs content verification for a static web page by retrieving a URL (Uniform Resource Locator) or by capturing the page using a browser plug-in. Verification technologies typically determine whether the web content violates predefined rules, which may be related to accessibility, corporate branding, copyright rules, or other standards.

Web 2.0 technologies, user-generated content, and increased use of animation and Flash content “partially updates” a web page without changing the web page's URL. In turn, a client's web page includes a portion of the content in the initial page that is not verified. In addition, authorized users may create and publish content (i.e. content creators) on a web page that has not proceeded through verification steps.

### SUMMARY

A client-side application receives an initial page from an application server that includes initial content and provides the initial page to a user. Next, the client-side application receives user input corresponding to the initial page and updates a portion of the initial content, which results in updated content and unmodified initial content. Subsequently, the client-side application formats the updated content and adds markup tags that describe the updated content. The client-side application then sends the updated content and the markup tags to a verification server. As a result, the client-side application receives a verification report from the verification server that corresponds to the updated content and the markup tags. The client-side application determines whether the verification report includes a verification error and, if so, the client-side application provides the verification error to the user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing a client utilizing a verification server to verify updated content;

FIG. 4 is a diagram showing a client-side application utilizing a verification server to verify user published content;

FIG. 5A is a diagram of an initial page that a user requests from an application server;

FIG. 5B is a diagram showing a user performing an action that partially updates a web page;

FIG. 6A is a diagram of an initial page that a user requests from an application server that includes areas for which the user to enter information;

FIG. 6B is a diagram showing a user entering content into a web page;

FIG. 7 is a flowchart showing steps taken in a client-side application receiving a partial page request and processing the partial page;

FIG. 8 is a flowchart showing steps taken in a client-side application receiving user input and verifying the user input; and

FIG. 9 is a flowchart showing steps taken in a verification server receiving updated content and verifying the updated content.

### DETAILED DESCRIPTION

Certain specific details are set forth in the following description and figures to provide a thorough understanding of various embodiments of the invention.

Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

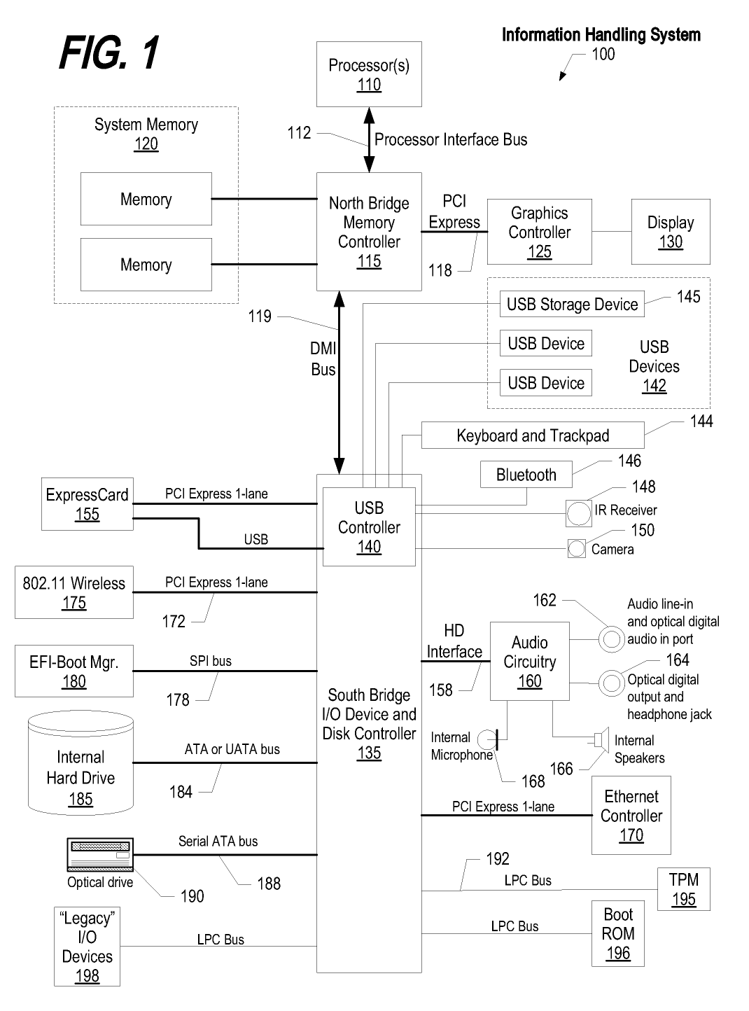

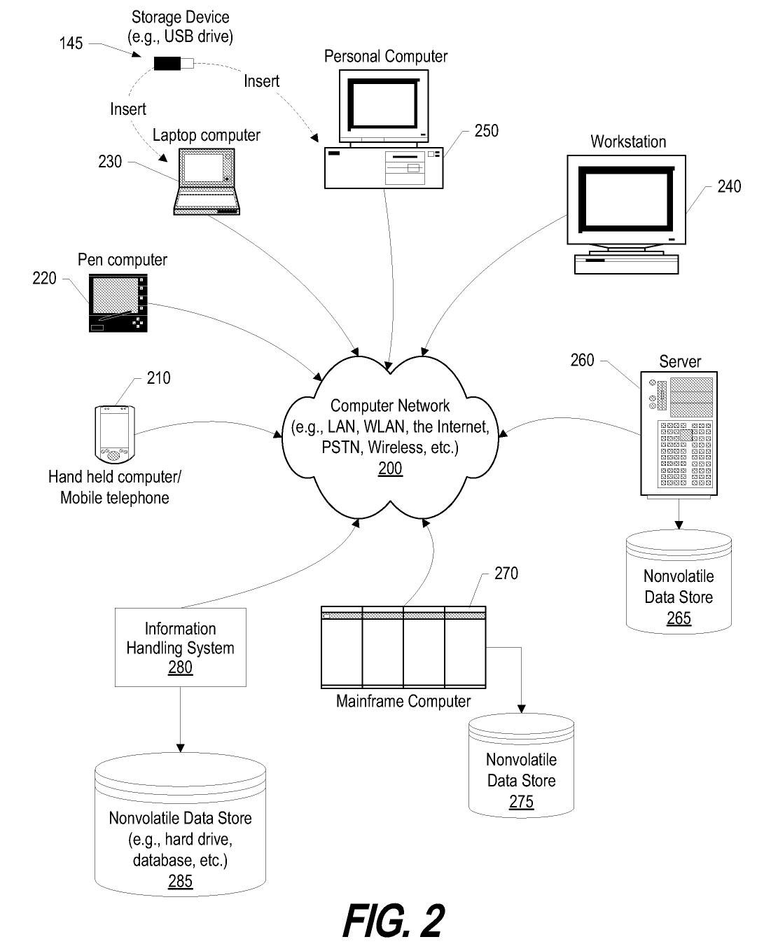

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

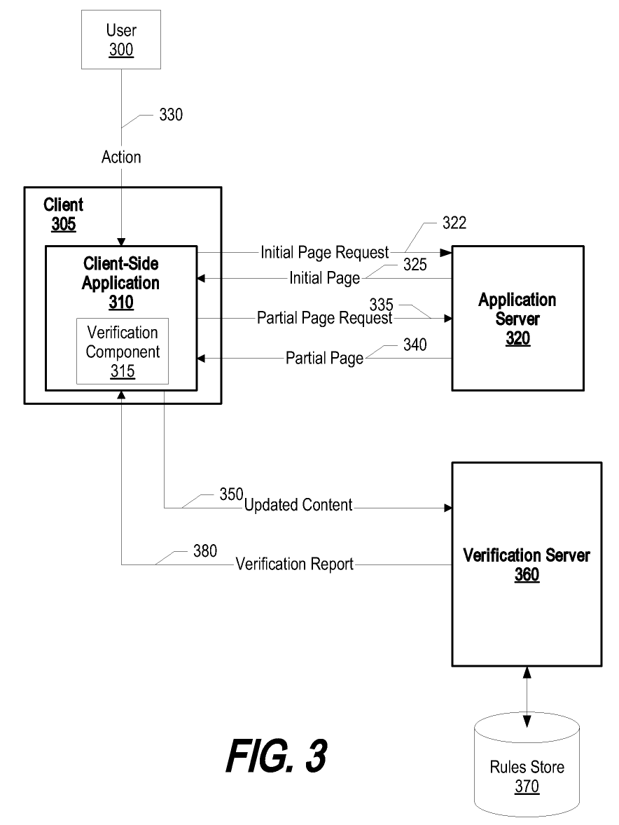

FIG. 3 is a diagram showing a client utilizing a verification server to verify updated content. Client 305 includes client-side application 310 that requests and displays content, such as a browser requesting a web page. Client-side application 310 includes verification component 315 that monitors content activity. Verification component 315 may be a plug-in or extension to client application 310 or may be embedded in the content requested from application server 320. When content partially updates, such as partially updating a web page, verification component 315 detects, retrieves, and sends the partial update (updated content 350) to verification server 360 to verify. As a result, client-side application 310 utilizes a server-based verification (verification server 360) to verify updated content 350. The content displayed in the client application may include various content types such as HTML (hyper text markup language), ODF (open document format), PDF (portable document format), XML (extensible markup language), and etcetera. Content along with markups of the content are sent to the verification server to verify. In one embodiment, updated content 350 may need to be converted into a format supported by the verification server before sending to the verification server. In another embodiment, the content which is sent to verification server may include additional information, such as markup tags that describe updated content 350, location information of the content in the page, so that the content can be verified in the context of the entire page and/or so that the markup tags themselves may be verified.

User 300 provides input 330 to client-side application 310 to view particular content, such as a web page. Input 330 may be a user action, such as a mouse click, to select a link to a particular web page. In turn, client-side application 310 sends initial page request 322 to application server 320. Application server 320 sends initial page 325 to client-side application 310, which client-side application 310 displays on a display for user 300 to view. For example, user 300 may wish to view a weather forecast and, in this example, the web page displays current weather information along with tabs to view extended forecasts, etcetera.

User 300 views the initial page and wishes to view information that the initial page does not include. Using the example described above, user 300 may wish to view an extended forecast and select a tab labeled “Extended Forecast” by providing another input 330 (e.g., mouse click) that selects the tab. As such, client-side application 310 sends partial page request 335 to application server 320, which does not include a different address location (uniform resource locator (URL)) but includes a request for data that is loaded onto the initial page within client-side application 310. Application server 320 sends partial page 340 to client-side application 310, which client-side application 310 displays for user 300 to view. Verification component 315 identifies partial page 340 as “updated content” and, as a result, formats the updated content as needed and sends updated content 350 to verification server 360. Updated content 350 include the new content and markups of the content, formatting of the content as well as additional information about the content in the page for verification server 360 to verify.

Verification server 360 retrieves verification rules from rules store 370 and checks updated content 350 against the verification rules for compliance. For example, a verification rule may require alternative text to be associated with some content features such as images and interactive form fields. In this example, verification server 360 applies the rule to such content feature and report whether violations to the rule exists in the supplied content.

Verification rules may be interpreted from a industrial specification, such as Web Content Accessibility Guidelines (WCAG) from The World Wide Web Consortium (W3C), or a government regulation or law, for instance, Section 508 of the Rehabilitation Act. In one embodiment, updated content 350 may also include information to specify what verification rules should be used to verify the content. In another embodiment, updated content 350 may include the verification rules in which verification server 360 utilizes to check updated content 350.

Once checked, verification server 360 creates verification report 380 and sends verification report 380 to client-side application 310. Verification component 315 receives verification report and may log the error or display an error message to user 300 if verification server 360 detected one or more verification errors in updated content 350.

In one embodiment, the initial page may include automatically updated information, such as stock quotes or news ticker information. In this embodiment, user 300 may not request updates but, rather, application server 320 provides them automatically. As such, verification component 315 detects the updates and sends them to verification server 360 for verification.

The process of verifying updated content 350 is independent of application logic (application server 320), which allows the verification to be based on a policy that applies to a collection of applications, rather than requiring the verification to be implemented in every application individually. As such, updated content verification may be performed by configuring application server 320 to include verification component 315, without modifying the business logic or application logic of application server 320. Verification does not require user action and, in turn, user 300 is unaware of verifying updated content 350 unless verification server 360 detects an error. In another embodiment, user 300 is unaware of the errors, which are logged.

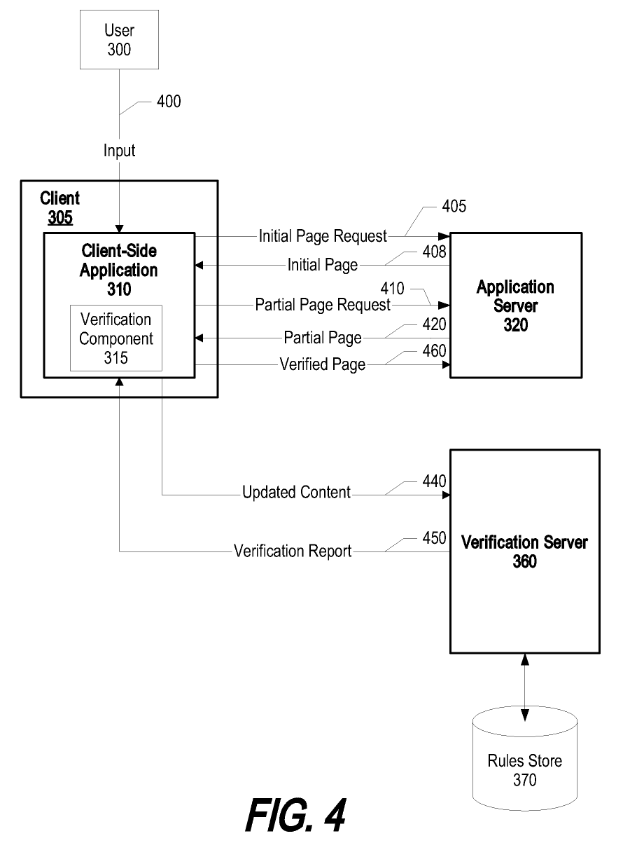

FIG. 4 is a diagram showing a client-side application utilizing a verification server to verify user published content. Client-side application 310 includes verification component 315 that monitors user input 400, such as when user 300 publishes content on a web page. When user 300 publishes content, verification component 315 sends the content to be published (updated content 350) to verification server 360 to verify.

User 300 provides input 400 to client-side application 310 to access particular content. Input 400 may be a user action, such as a mouse click, to select a link to a particular web page. In turn, client-side application 310 sends initial page request 405 to application server 320. Application server 320 sends initial page 408 to client-side application 310, which client-side application 310 displays on a display for user 300 to view. For example, user 300 may be a reporter and, in this example, user 300 may request a news article template from the news reporter's company web site.

User 300 views the initial web page and wishes to enter content into the initial page, such as entering a news article. User 300 provides input 400, such as text and/or image selections to include in the news article. In turn, client-side application 310 may send partial page requests 410 to application server 320 to assist client-side application 310 in processing input 400.

For example, a news reporter may enter the text “New Technology Trade Show” into an input control title field and include formatted text and/or images into a body text area. When the news reporter presses a “Submit” button, verification component 315 intercepts the request, formats the content as required by the verification server, and adds additional information required by the verification server. For example, if the content is an HTML fragment, additional HTML tags may be required so that the content can be verified as a full HTML page. If the fragment is related or is a part of another part in the page, the location of the content in the page may need to be added to the content so that the verification server can properly incorporate the content into the page that is cached in the verification server in order to verify the content in the context of the entire page. Verification component 310 then sends updated content 440, which includes the content to be submitted by the user, markups of the content, as well as additional formatting or location information, to verification server 360 for verification.

Verification server 360 retrieves verification rules from rules store 370 and checks updated content 440 against the verification rules. In one embodiment, content 440 may include information to specify what verification rules should be used to verify the content. In another embodiment, updated content 440 may also include the verification rules in which verification server 360 utilizes to check updated content 440.

Once checked, verification server 360 creates verification report 450 and sends verification report 450 to client-side application 310. Verification component 315 receives verification report 450 and determines whether updated content 440 is compliant based upon verification report 450. If compliant, client-side application 310 sends verified page 460 to application server 320 to publish. Using the example discussed above, client-side application 310 sends the news article, which may include images, to application server 320 to publish. On the other hand, if verification report 450 includes an error, the submission is rejected, and a message may display to user 300 that indicates the error and steps to take to correct the error.

In one embodiment, the content to be published may be an attachment. In this embodiment, when user 300 uploads the attachment, verification component 315 intercepts the upload request and the attachment file is sent to the verification server to verify.

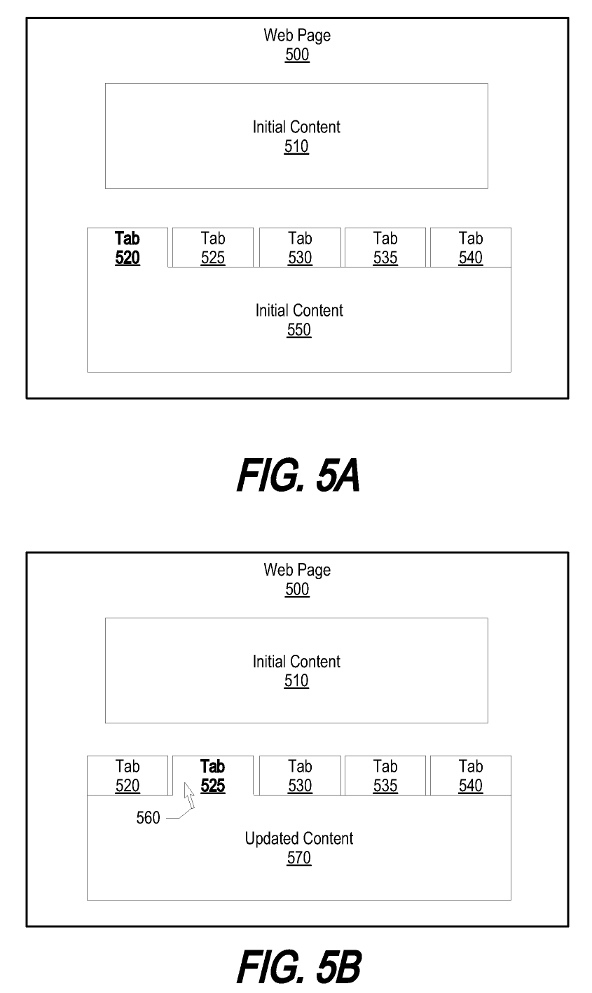

FIG. 5A is a diagram of an initial page that a user requests from an application server. A user requests web page 500 from a server by, for example, entering a URL location in the web browser. In turn, the web browser provides markup language that the browser displays on the user's monitor.

Web page 500 includes initial content 510, which may be a web page heading or other general information pertaining to web page 500's company. Web page 500 also includes tabs 520-540 that a user may select to view different content, such as education materials, product descriptions, or support materials (see FIG. 5B and corresponding text for further details). The example shown in FIG. 5A shows that tab 520 is initially selected that displays initial content 550.

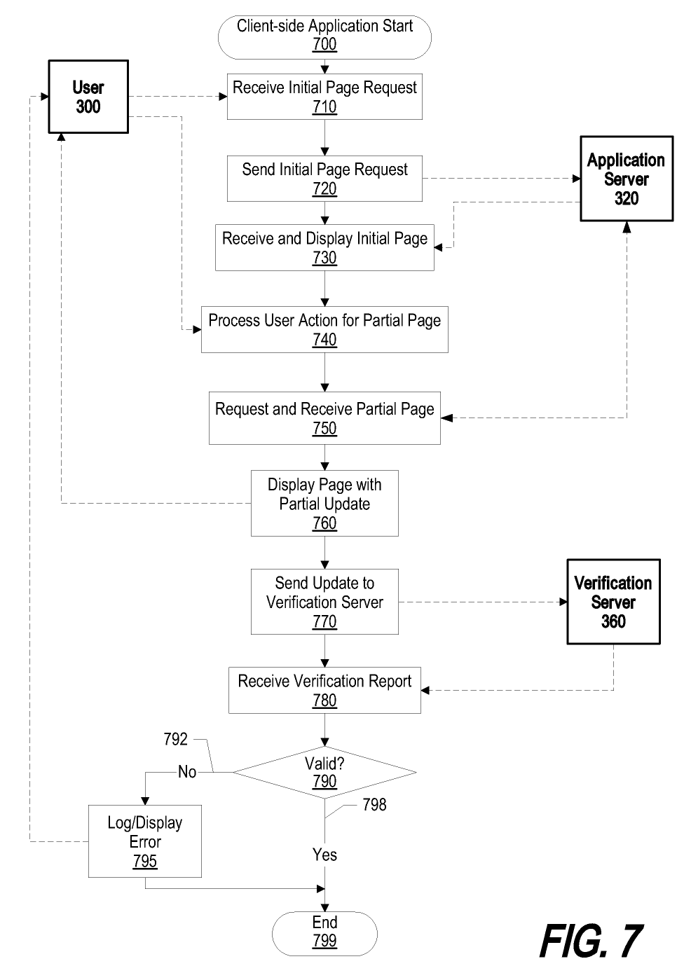

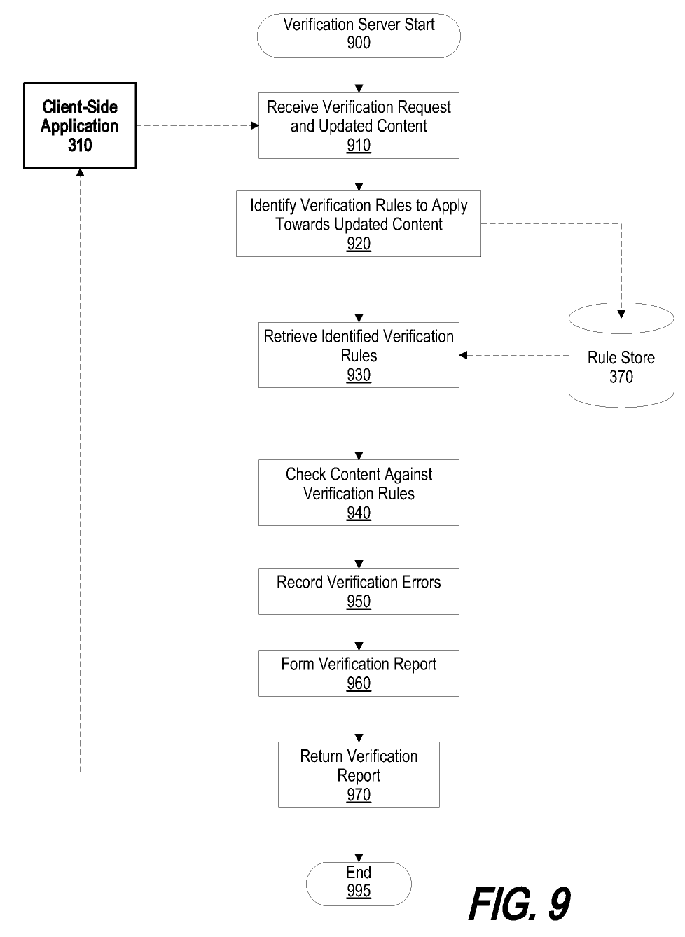

FIG. 5B is a diagram showing a user performing an action that partially updates a web page. Web page 500 is the same as that shown in FIG. 5A with the exception that a user selects tab 525 with pointer 560. When the user selects tab 525, the web browser sends a partial page request to the application server, which returns a partial page of data. In turn, the web browser displays the partial page of data as updated content 570. As a result, web page 500 includes initial content 510 along with updated content 570. The web browser may format and send updated content 570 to a verification server in order for the server to verify whether updated content 570 meets particular rules, such as whether each image and interactive form field in the content includes an associated alternative text. (see FIGS. 7, 9, and corresponding text for further details). While formatting, the web browser adds markup tags that describe updated content 570.

In one embodiment, FIG. 5B may include automatically updated information, such as stock quotes, weather data, or news ticker information. In this embodiment, the user may not request updates but, rather, the application server provides them automatically. As such, the web browser may format and then sends the automatically updated information to the verification server for verification.

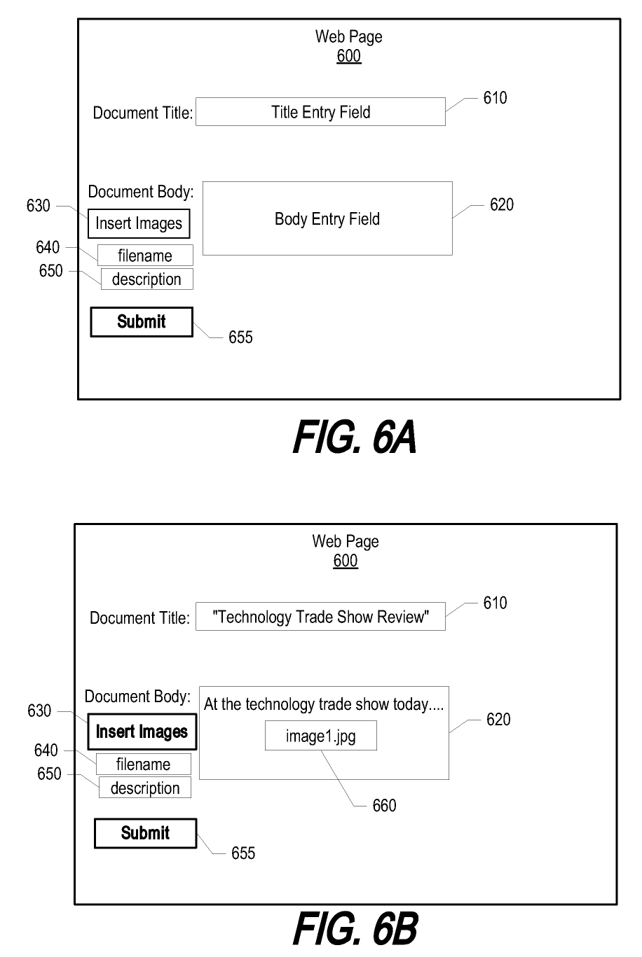

FIG. 6A is a diagram of an initial page that a user requests from an application server that includes areas for which the user to enter information. For example, a reporter may request a news article template from the reporter's company application server, which the reporter uses to write a news article.

The user's web browser requests and receives an initial page from an application server and displays web page 600 for the user to view. Web page 600 includes initial content, which includes title and label information, text boxes 610-620, 640-650, and buttons 630 and 655.

Using the example discussed above, a reporter enters a title of the news article in box 610 and writes the news article in box 620. The reporter may also insert images into the news article by selecting button 630, entering the images file name and path in box 640, and entering an image description in box 650 (see FIG. 6B and corresponding text for further details).

FIG. 6B is a diagram showing a user entering content into a web page.

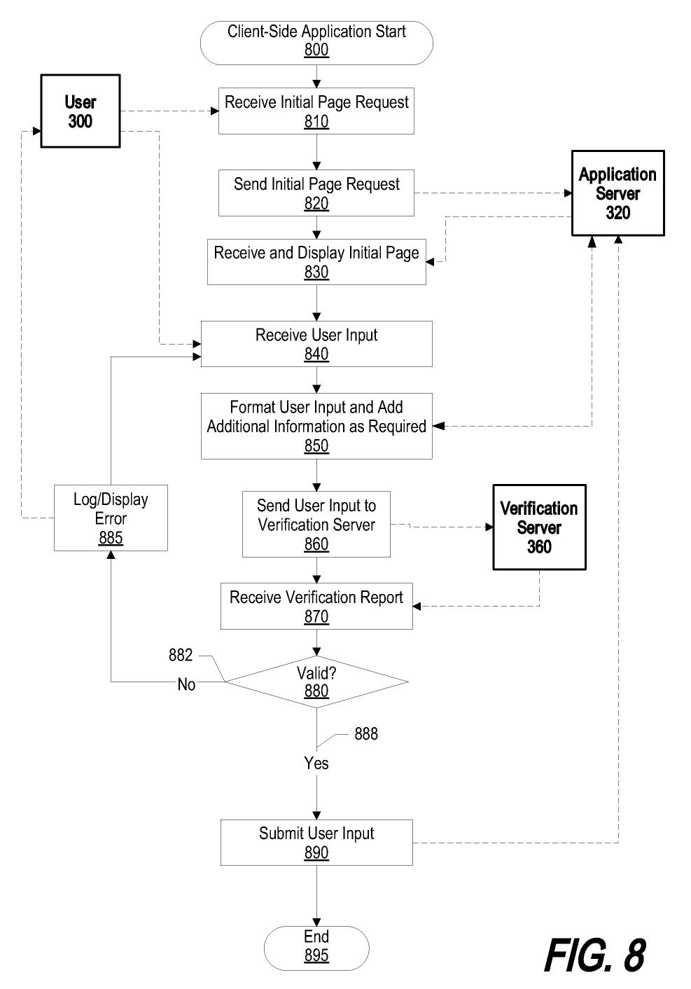

Web page 600 is the same as that shown in FIG. 6A with the exception of a user's entered contents. FIG. 6B shows that a user entered content in text box 610, and also entered text and image 660 in box 620. In turn, the user selects submit button 655 and the web browser sends the content to be submitted, markups of the content, and additional formatting and location formation to a verification server for verification. Once the verification component receives a successful verification, the web browser sends the content to be submitted to the application server for publishing (see FIGS. 8, 9, and corresponding text for further details). If the verification server receives any verification error, the submission is rejected, and a message may display to the user to indicate the errors and steps to take to correct the errors.

FIG. 7 is a flowchart showing steps taken in a client-side application receiving a partial page request and processing the partial page. Client-side application processing commences at 700, whereupon the client-side application receives an initial page request from user 300 at step 710. For example, a web browser may receive a request from user 300 to view a web page. At step 720, the client-side application sends an initial page request to application server 320 and, at step 730, the client-side application receives and displays the initial page for user 300 to view.

User 300 views the initial page and provides user input, such as a user action that selects a tab included in the initial page (step 740). The client-side application requests a partial page from application server 320 and receives the requested partial page from application server 320 at step 750. For example, the initial page may be similar the example shown in FIG. 5A and, in this example, the user selects tab 525, which results in the client-side application requesting and receiving updated content 570 shown in FIG. 5B. As discussed earlier, since the client-side application requested a partial page of data, a location address corresponding to the initial page does not change.

At step 760, the client-side application displays the page that includes unmodified initial content (initial content that was not modified) and updated content for user 300 to view. The client-side application sends formatted updated content, which includes the updated content, markups, and additional formatting and location information to verification server 360 to verify (see FIG. 9 and corresponding text for further details). In one embodiment, the client-side application also sends additional information to indicate which verification rules to use. In another embodiment, client-side application sends verification rules along with the updated content to verification server 360 to utilize when verifying the updated content.

The client-side application receives a verification report from verification server 360 at step 780. The verification report includes verification errors (if any) that were generated while verification server 360 was verifying the updated content. A determination is made as to whether the updated content is compliant based upon the verification report (decision 790). If the updated content is compliant, decision 790 branches to “Yes” branch 798 whereupon processing ends at 799. On the other hand, if the updated content is not compliant, decision 790 branches to “No” branch 792 whereupon processing logs and/.or displays an error for user 300 to view, which informs user 300 that the updated content is not compliant (step 795). Processing ends at 799.

FIG. 8 is a flowchart showing steps taken in a client-side application receiving user input and verifying the user input. Processing commences at 800, whereupon the client-side application receives an initial page request from user 300 at step 810. At step 820, the client-side application sends the initial page request (includes an address location) to application server 320. In turn, application server 320 provides an initial page, which the client-side application displays at step 830. For example, user 300 may be a reporter and, in this example, user 300 may request a news article template from the news reporter's company web site in which application server 320 manages.

Processing receives user input at step 840, such as a news article. At step 850, processing formats the user input and adds markup tags and other additional information as needed. The markup tags describe the updated content. For example, processing may add markup tags to an image when a verification rule requires alternative text to be associated with the image (e.g., <img . . . />). In one embodiment, processing includes partial page updates due to content generation on client-side and/or requested from application server 320. For example, user 300 may enter an article title “Technology on the Rise,” into the client-side application's input control. In this example, when user 300 presses a submit button, the verification component in client-side application may need to convert the text into HTML. In one embodiment, the verification component adds additional location information to the content so that the content can be verified in the context of the entire page. Next, processing sends the user-inputted content as well as any additional formatting and location information to verification server 360 (step 860). Continuing with the example above, processing sends the resulting HTML to verification server 360.

At step 870, processing receives a verification report from verification server 360, and a determination is made as to whether the user input is compliant based upon the results of the verification report (decision 880). If the user input is not compliant, decision 880 branches to “No” branch 882 whereupon processing loops back to display an error message (step 885) and receive more user input. This looping continues until the user input is compliant, at which point decision 880 branches to “Yes” branch 888 whereupon processing submits the user input to application server at step 890. Processing ends at 895.

FIG. 9 is a flowchart showing steps taken in a verification server receiving updated content and verifying the updated content. Processing commences at 900, whereupon the verification server receives a verification request from client-side application 310 to verify updated content (step 910). At step 920, the verification server identifies verification rules located in rule store 370 to apply to the updated content. In one embodiment, the verification server selects verification rules among multiple rule sets based on the content type.

In another embodiment, the client-side application provides information to indicate which rules to use. For example, the client-side application 310 may indicate to use Web Content Accessibility Guidelines (WCAG) rules for verification. Yet in another embodiment, client-side application 310 provides the verification rules to the verification server when client-side application 310 sends the verification request. For example, client-side application 310 may provide a customized rule to limit the use of colors in images in order to improve the experience of individual with color vision deficiencies.

The verification server receives the identified verification rules from rule store 370 at step 930, and checks the updated content and markup tags against the verification rules at step 940. For example, if any image or interactive form field does not have associated text, a violation to the rule is reported. In another example, the verification server may verify markup tags corresponding to an image when a verification rule requires alternative text to be associated with the image (e.g., <img . . . />). The verification server records verification errors (if any) at step 950, and forms a verification report at 960 that includes identified verification errors. The verification server sends the verification report to client-side application 310 at step 970, and ends at 980.

One of the preferred implementations of the invention is a combination of client and server applications, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving, at a client-side application, an initial page from an application server, the initial page including initial content;
providing the initial page to a user;
receiving user input from the user, the user input corresponding to the initial page;
in response to receiving the user input, updating a portion of the initial content, the updated portion of the initial content becoming updated content and the non-updated portion of the initial content becoming unmodified initial content;
formatting the updated content by adding markup tags that describe the updated content;
sending, from the client-side application, the updated content and the markup tags to a verification server;
receiving, at the client-side application, a verification report from the verification server, the verification report corresponding to the updated content and the markup tags;
determining whether the verification report includes a verification error; and
in response to determining that the verification report includes the verification error, providing the verification error to the user.

2. The method of claim 1 wherein the verification error indicates that the markup tags are not valid.

3. The method of claim 1 further comprising:
in response to receiving the user input, sending a partial page request to the application server;
receiving a partial page from the application server that corresponds to the partial page request;
identifying the partial page as the updated content;
sending, from the client, the partial page to the verification server;
receiving a subsequent verification report from the verification server that corresponds to the partial page; and
in response to determining that the subsequent verification report does not include a subsequent verification error, sending the partial page to the application server.

4. The method of claim 1 wherein the client-side application is a browser, the method further comprising:
extracting the updated content from the browser using a verification component located at the client; and
sending the extracted updated content to the verification server using the verification component.

5. The method of claim 4 further comprising:
wherein the client-side application receives the verification component, which is included in the initial page, from the application server; and
wherein the verification component sends verification rules to the verification server that the verification server utilizes to verify the updated content.

6. The method of claim 1 wherein the client-side application only sends the updated content, without the unmodified initial content, to the verification server.

7. The method of claim 1 wherein an address location corresponding to the initial page remains unchanged after the updating of the portion of the initial content.

8. A computer program product stored in a computer readable medium, comprising functional descriptive material that, when executed by an information handling system, causes the information handling system to perform actions that include:
receiving, at a client-side application, an initial page from an application server, the initial page including initial content;
providing the initial page to a user;
receiving user input from the user, the user input corresponding to the initial page;
in response to receiving the user input, updating a portion of the initial content, the updated portion of the initial content becoming updated content and the non-updated portion of the initial content becoming unmodified initial content;
formatting the updated content by adding markup tags that describe the updated content;
sending, from the client-side application, the updated content and the markup tags to a verification server;
receiving, at the client-side application, a verification report from the verification server, the verification report corresponding to the updated content and the markup tags;
determining whether the verification report includes a verification error; and
in response to determining that the verification report includes the verification error, providing the verification error to the user.

9. The computer program product of claim 8 wherein the verification error indicates that the markup tags are not valid.

10. The computer program product of claim 8 wherein the information handling system further performs actions that include:
in response to receiving the user input, sending a partial page request to the application server;
receiving a partial page from the application server that corresponds to the partial page request;
identifying the partial page as the updated content;
sending, from the client, the partial page to the verification server;
receiving a subsequent verification report from the verification server that corresponds to the partial page; and
in response to determining that the subsequent verification report does not include a subsequent verification error, sending the partial page to the application server.

11. The computer program product of claim 8 wherein the client-side application is a browser, the information handling system further performing actions that include:
extracting the updated content from the browser using a verification component located at the client; and
sending the extracted updated content to the verification server using the verification component.

12. The computer program product of claim 11 wherein the information handling system further performs actions that include:
wherein the client-side application receives the verification component, which is included in the initial page, from the application server; and
wherein the verification component sends verification rules to the verification server that the verification server utilizes to verify the updated content.

13. The computer program product of claim 8 wherein the client-side application only sends the updated content, without the unmodified initial content, to the verification server.

14. The computer program product of claim 8 wherein an address location corresponding to the initial page remains unchanged after the updating of the portion of the initial content.

15. An information handling system comprising:
one or more processors;
a memory accessible by at least one of the processors;
a nonvolatile storage area accessible by at least one of the processors;
a set of instructions stored in the memory and executed by at least one of the processors in order to perform actions of:
receiving, at a client-side application, an initial page from an application server, the initial page including initial content;
providing the initial page to a user;
receiving user input from the user, the user input corresponding to the initial page;
in response to receiving the user input, updating a portion of the initial content, the updated portion of the initial content becoming updated content and the non-updated portion of the initial content becoming unmodified initial content;
formatting the updated content by adding markup tags that describe the updated content;
sending, from the client-side application, the updated content and the markup tags to a verification server;
receiving, at the client-side application, a verification report from the verification server, the verification report corresponding to the updated content and the markup tags;
determining whether the verification report includes a verification error; and
in response to determining that the verification report includes the verification error, providing the verification error to the user.

16. The information handling system of claim 15 wherein the verification error indicates that the markup tags are not valid.

17. The information handling system of claim 15 wherein the information handling system further performs actions that include:
in response to receiving the user input, sending a partial page request to the application server;
receiving a partial page from the application server that corresponds to the partial page request;
identifying the partial page as the updated content;
sending, from the client, the partial page to the verification server;
receiving a subsequent verification report from the verification server that corresponds to the partial page; and
in response to determining that the subsequent verification report does not include a subsequent verification error, sending the partial page to the application server.

18. The information handling system of claim 15 wherein the client-side application is a browser, the information handling system further performing actions that include:
extracting the updated content from the browser using a verification component located at the client; and
sending the extracted updated content to the verification server using the verification component.

19. The information handling system of claim 18 wherein the information handling system further performs actions that include:
wherein the client-side application receives the verification component, which is included in the initial page, from the application server; and
wherein the verification component sends verification rules to the verification server that the verification server utilizes to verify the updated content.

20. The information handling system of claim 15 wherein the client-side application only sends the updated content, without the unmodified initial content, to the verification server.
